(19) United States
(12) Patent Application Publication
(10) Pub. No.: US 2026/0177374 A1
(43) Pub. Date: Jun. 25, 2026

(54) METHOD AND COORDINATE MEASURING MACHINE

(71) Applicant: Klingelnberg GmbH, Hückeswagen (DE)

(72) Inventors: Markus Finkeldey, Hattingen (DE); Jonas Stefer, Wipperfürth (DE)

(21) Appl. No.: 18/832,285

(22) PCT Filed: Jan. 20, 2023
(86) PCT No.: PCT/EP2023/051337

§ 371 Date: Aug. 8, 2024

(30) Foreign Application Priority Data
Jan. 26, 2022 (EP) 22153544.6

(51) Int. Cl. G01B 11/00

(52) U.S. Cl. CPC G01B 11/007

(57) ABSTRACT

A method for measuring coordinates, the method including the steps of:—providing a component on a coordinate measuring machine, wherein the coordinate measuring machine has an optical measuring system. An available measuring range of the optical measuring system is specified by a non-homogenous spectrum of a light source of the optical measuring system. The method further includes the step of measuring a geometric feature to be measured of the component, wherein a reduced measuring range is used which is smaller than the available measuring range.

### CROSS-REFERENCE TO RELATED APPLICATIONS

This application is a 35 U.S.C. § 371 National Stage patent application of PCT/EP2023/051337 filed 20 Jan. 2023, which claims the benefit of European patent application 22153544.6 filed 26 Jan. 2022, the disclosures of which are incorporated herein by reference in their entirety.

### TECHNICAL FIELD

The subject matter of the disclosure is a method for measuring a component and a coordinate measuring machine for carrying out such a method.

### BACKGROUND

Gearwheels are often measured in a tactile manner, i.e. mechanically by probing, on coordinate measuring machines. Tactile measuring methods are very precise, but have the disadvantage of a long measuring time. A probe that scans the gearwheel must be threaded into each gap in the gearing, brought into contact with the tooth flank to be scanned and withdrawn from the gap again after the tooth flank has been scanned. The probe is then threaded into the next tooth space and the process is repeated.

The performance of purely optical, i.e. non-contact, sensors for measuring the geometry of a gearing has improved considerably in recent years. Coordinate measuring machines for gear measurement therefore increasingly feature optical sensors, which are used as an alternative or supplement to tactile probes. Examples of optical sensors for gear measuring technology are cameras, laser triangulation systems, interferometric systems, confocal or confocal chromatic systems, systems for fringe light projection or focus variation.

From the European patent applications EP 3 786 573 A1 and EP 3 611 463 A1, for example, it is known to use confocal chromatic sensors to measure gear geometry. Confocal chromatic sensors for distance measurement combine the confocal properties known from confocal microscopy with the possibility of spectral or wavelength-dependent evaluation. The mechanism of dispersion, i.e. the wavelength-dependent propagation speed of light, is used here. This generates the longitudinal chromatic aberration of a lens, which ensures that the light is focused at different depths (distances) in front of the lens depending on the wavelength. By using a spectrometer, light waves returning to the component being measured can be assigned to their depth by reflection or scattering. The measuring range of such a confocal chromatic sensor is therefore determined by the spectrum of a light source of the confocal chromatic sensor.

FIG. 1 schematically illustrates the mode of operation of a confocal chromatic sensor KF. A measuring range M of the confocal chromatic sensor KF results from the fact that wavelengths, designated here as 1, 2 and 3 by way of example, are focused at different, known distances from the sensor KF. The position of an optically detected measuring point MP of a gearwheel Z can therefore be determined by a spectral evaluation of the reflected light.

The homogeneity of a light source LQ of the confocal chromatic sensor KF has a decisive influence on the quality of the measurement results. FIG. 2 shows an example of the relative radiant power I of the light source LQ plotted against the wavelength A. It can be seen that the relative radiant power I of the light source LQ is inhomogeneous and that the wavelengths 1, 2, 3 selected as examples from the measuring range are provided with different radiant powers.

In measurement mode with the confocal chromatic sensor KF, which uses this light source LQ, it may not be possible to reliably detect certain measuring points on the gearwheel Z if these are located in a section of the measuring range M of the confocal chromatic sensor KF, the wavelengths of which are provided with low radiant power. In the example shown here, the measuring point MP to be detected on the gearwheel Z lies in the focus of wavelength 2, which is provided by the light source LQ with very low radiant power. This low radiant power results in a low intensity reflected back to a detector D of the confocal chromatic sensor KF for wavelength 2, so that the measuring point MP may not be correctly detected in the constellation shown here.

### SUMMARY

Against this background, the present disclosure is based on the technical problem of specifying a method and a coordinate measuring machine which enable reliable measurement of a geometry of a component by means of an optical measuring system whose available measuring range is predetermined by an inhomogeneous spectrum of a light source of the optical measuring system.

The technical problem described above is solved in each case by the independent claims. Further embodiments of the disclosure result from the dependent claims and the following description.

According to a first aspect, the disclosure relates to a method comprising the following method steps: providing a component on a coordinate measuring machine, wherein the coordinate measuring machine has an optical measuring system and wherein an available measuring range of the optical measuring system is predetermined by an inhomogeneous spectrum of a light source of the optical measuring system; measuring a geometric feature of the component to be measured, wherein a reduced measuring range is used, wherein the reduced measuring range is smaller than the available measuring range.

The method according to the disclosure provides for a restricted or reduced measuring range of the optical measuring system to be used for a measurement task. For example, it may be the case that the surface properties of a component to be measured or unfavorable geometric conditions, for example limited available probing angles or the like, mean that certain wavelengths or wavelength ranges provided by the light source with lower relative radiant power are not suitable for probing measuring points for this particular measurement task. In particular, it may therefore be provided that the reduced measuring range is selected or specified against the background of a component-specific measurement task.

It may be provided that the reduced measuring range is set by restricting a spectral bandwidth of the optical measuring system. The reduced measuring range can be set, for example, on a component-specific basis, so that the reduced measuring range is set, for example, as a function of a component geometry, component surface or the like to be measured. For example, it may be provided that a filter device or a filter element is adapted to set the reduced spectral bandwidth.

It may be provided that the filter device or the filter element are an integral part of the light source and, in particular, are integrated into a housing of the light source. It may be provided that the filter device or the filter element is an integral part of the optical measuring system.

The inhomogeneous spectrum of the light source can be limited to a range of 400 nm-800 nm. The abbreviation “nm” stands for nanometer.

Alternatively, it may be provided that the reduced measuring range is specified by limiting the spectral bandwidth of the optical measuring system. In particular, the limited bandwidth of the coordinate measuring machine can be fixedly predetermined. For example, it may be provided that a filter device or a filter element is integrated into a light source or a detector. In particular, it may be provided that the limited bandwidth of the coordinate measuring machine is not set for a specific component before measurement, but is used for each component to be measured.

If reference is made in the present case to an inhomogeneous spectrum of the light source, this means that the light source emits wavelengths with different relative radiant power depending on the wavelength. It may therefore be provided that a first wavelength of the inhomogeneous spectrum is provided with a first relative radiant power and that a second wavelength of the inhomogeneous spectrum is provided with a second relative radiant power, with the first relative radiant power being lower than the second relative radiant power.

For example, it may be provided that the light source has an exciting light source, wherein the exciting light source may be a laser or an LED, for example. In the present case, a laser is preferably used as the exciting light source.

It may be provided that the light source comprises an excited light source, which may also be referred to as an excited medium, such as a phosphor layer or the like.

The inhomogeneous spectrum of the light source can be generated, for example, by the exciting light source exciting the excited light source to emit a light output, so that the light of the light source as a whole is composed of the exciting light of the exciting light source and the excited light of the excited medium. An intensity spectrum of such a light source usually has two intensity peaks-namely a first intensity peak of the exciting light and a second intensity peak of the excited light.

It is understood that three or more media can also be excited to glow by means of an exciting light source, so that an inhomogeneous spectrum can also have the corresponding number or more intensity peaks.

In particular, the inhomogeneous spectrum may have two or more intensity peaks resulting from the superposition of the spectra of an exciting light source and two or more excited light sources.

It may be provided that the light source is assigned an optical fiber into which the light from the inhomogeneous light source is coupled.

A restriction of the spectral bandwidth of the optical measuring system therefore means that certain wavelengths or wavelength ranges of the light source are not used to detect measuring points.

The spectral bandwidth of the optical measurement system can be restricted by limiting the spectral bandwidth of a detector of the optical measurement system. For example, a spectral filter device can be assigned to the detector, which can be connected upstream of the detector or integrated into the detector. Two or more spectral filter devices can be assigned to the detector.

A spectral filter device can have one filter element or can have several filter elements, in particular of the high-pass, low-pass or band-pass type or a combination thereof. In the present case, a high-pass filter is preferably used, which only allows wavelengths above a specified threshold to pass, i.e. only those wavelengths that are greater than a specified wavelength.

The spectral bandwidth of the detector can be limited by not reading out one or more areas of the detector.

The detector can be a wavelength-dependent detector, in particular a spectrometer. The detector can be a CCD spectrometer or a CMOS spectrometer.

Alternatively or additionally, the spectral bandwidth of the optical measuring system can be restricted by adjusting the evaluation of measured values. All measured values that are not assigned to the specified reduced measuring range can therefore be hidden or sorted out.

The spectral bandwidth of the optical measurement system can be narrowed by adjusting the light emitted by the light source after it hits the component. In other words, the spectral bandwidth can be narrowed after the light emitted by the light source has been reflected by the component or scattered by the component.

The spectral bandwidth of the optical measuring system can be restricted by limiting the spectral bandwidth of the light source of the optical measuring system.

For example, at least one spectral filter device can be assigned to the light source. In particular, two or more spectral filter devices can be assigned to the light source. A spectral filter device can have one filter element or can have several filter elements, in particular of the high-pass, low-pass or band-pass type or a combination thereof.

The light source can have a laser and the laser can be detuned to limit the spectral bandwidth of the light source.

Alternatively or additionally, the optical measuring system can have one or more of the light sources listed below: Xenon or halogen lamps, white light LED, laser pumped phosphor layers, super-continuum light source, fiber laser, superluminescent diodes or the like.

The spectral bandwidth of the optical measuring system can be narrowed by adjusting the light emitted by the light source before it hits the component. In other words, the spectral bandwidth can be narrowed before the light emitted by the light source is reflected by the component or scattered by the component.

It may be provided that the reduced measuring range of the optical measurement system is determined prior to measurement, wherein the determination of the reduced measuring range comprises the following method steps: Providing one or more parameters of the optical measurement system, such as the numerical aperture, the bandwidth and the distribution of the spectrum of the light source or the like; providing one or more component-specific parameters, such as a roughness of a component surface, an angle of incidence of a measuring light emitted by the light source, a measuring range required to detect the geometric feature to be measured, a target component geometry or the like; defining the reduced measuring range on the basis of one or more parameters of the optical measuring system and on the basis of one or more component-specific parameters.

The exemplary parameters of the optical measuring system and the component-specific parameters can therefore be used to select one or more wavelength ranges of the inhomogeneous spectrum of the light source that are suitable for the required measurement task.

The reduced measuring range can be determined numerically or empirically, in particular computer-aided with the aid of a coordinate measuring machine controller.

Alternatively or additionally, it may be provided that the determination of the reduced measuring range comprises the following method steps: measuring a reference component, wherein a quality criterion of an optical image of measurement points over the spectrum of the light source is recorded during the measurement; defining the reduced measuring range as a range or as a plurality of ranges of the spectrum for which the quality criterion is fulfilled.

The suitability of one or more wavelength ranges of the inhomogeneous spectrum of the light source for the required measurement task can be determined by measuring a reference component. The reference component can, for example, be a component from a batch of components to be measured, which is used in advance to set up the measurement.

For example, it may be provided that an exposure time and/or an illumination intensity is recorded for each measuring point detected on the component, wherein the quality criterion has threshold values of the exposure time and/or the illumination intensity to be fulfilled. If, for example, it is determined that certain measuring points are always detected with a low illumination intensity, a wavelength range of the inhomogeneous light source assigned to the measuring distance of the measuring points can be assessed as unsuitable, so that this wavelength range is not used for the intended measurement task.

It may be provided that both the exposure time and the illumination intensity are recorded for each measuring point, and the exposure time and the illumination intensity are calculated to form a quality criterion or a key figure for which a predefined threshold value or a predefined value range must be fulfilled. For example, it may be provided that a factor or a sum of an exposure time and illumination intensity assigned to a measuring point must exceed a predefined threshold value, wherein the assigned wavelength can be classified as unsuitable if the threshold value is not met.

Insofar as the reduced measuring range has been determined according to one or more of the aforementioned strategies, and accordingly a reduced measuring range has been selected which is suitable for measuring the geometric feature of the component to be measured, this reduced measuring range is set in particular by restricting the spectral bandwidth of the optical measuring system.

A first spectral bandwidth range can be assigned to the reduced measuring range and/or a second spectral bandwidth range can be assigned. A single spectral bandwidth range can therefore be assigned to the reduced measuring range or several spectral bandwidth ranges can be assigned. In particular, it may be provided that prior to the start of a measurement a selection is made between two or more spectral bandwidth ranges that are basically suitable for the required measurement task.

It may be provided that a relative radiant power is greater than a threshold value for each wavelength of the reduced measuring range. In the present case, the threshold value 11 is 1.3% of the maximum intensity of 100%. The diagram in FIG. 5 is to be understood schematically in this respect, as the threshold 11 has not been drawn at 1.3%.

For example, it may be provided that the threshold value is set at 1.3% of the maximum intensity of 100%. Alternatively, the threshold value can be set at 2% of the maximum intensity of 100%.

It may be provided that the inhomogeneous spectrum has two or more contiguous spectral bandwidth ranges that lie above the specified threshold value of the intensity required for measurement, which has been quantified above as 1.3% or 2% of the maximum possible intensity.

It may be provided that the spectral bandwidth range used for a measurement is selected depending on the measurement task. This is because a specific transfer function is obtained for each of the spectral bandwidth ranges, which indicates which depth measuring range for an optical distance measurement can be covered with the relevant spectral bandwidth range. For example, it may be the case that a depth measuring range of only 0-0.1 mm results for a bandwidth range of 200-400 nm, but the measurement task in question requires a measuring range of at least 0.0 mm to 0.5 mm. Accordingly, a bandwidth range of 400 nm to 800 nm, for example, would be suitable for this measurement task, which can be converted into precisely this depth measuring range of 0.0 mm to 0.5 mm.

The coordinate measuring machine can have a control device that is set up to adjust a target intensity of the light source to 50% of the maximum possible intensity within the reduced measuring range. In this way, the intensity can be increased or decreased, if necessary, within the reduced measuring range during a measurement for the detection of individual measuring points in order to reliably detect the measuring points in question.

If reference is made in the present case to a measurement task or a required measurement task, reference is made to the intended measurement of one or more geometric features on the component. Furthermore, a series of components can be measured, on each of which one or more geometric features are measured on the respective components of the series in question. The measurement task can therefore involve a single measurement of a component or a series measurement of a series of components.

It may be provided that the coordinate measuring machine has three linear axes for executing relative movements between the component and the optical measuring system, wherein a relative movement is executed in particular during the measurement by means of at least one of the linear axes. In particular, the three linear axes can be arranged orthogonally to one another, in the manner of a Cartesian coordinate system, and thus be set up to execute relative movements in three spatial directions oriented orthogonally to one another. In particular, it may be provided that the three linear axes support the optical measuring system so that the optical measuring system can be moved or adjusted relative to the component to be measured by means of the three linear axes.

It may be provided that the coordinate measuring machine has a rotational axis for executing a rotational component movement, wherein a rotation of the component is executed in particular during the measurement.

It may be provided that the coordinate measuring machine has a tactile sensor, in particular a measuring probe with a probe ball.

It may be provided that the component has a gearing or is a gearwheel, such as a bevel gear, a spur gear or the like.

It may be provided that the component is rotationally symmetrical. This means that the component has a central point or axis of rotation and that the geometry of the component can be mapped onto itself by rotating it around this point or axis of rotation. Examples of this include a star-shaped component or the aforementioned gearwheels. In principle, many regular polygons such as triangles, quadrilaterals and pentagons are also rotationally symmetrical.

It may be provided that the component has an outer diameter and/or an inner diameter known prior to the measurement. If the component is a gearwheel, for example, it can be provided that a tip circle diameter and/or a root circle diameter of the gearwheel are known before the measurement.

The reduced measuring range of the optical measuring system can be determined taking into account one or more previously known geometric features, in particular selected from the gearing features listed below: module, number of teeth, helix angle, pitch direction, tip circle diameter, root circle diameter, tip cone angle, root cone angle, spiral angle, spiral direction, tooth pitch.

It may be provided that one or more geometric features to be measured are measured, in particular selected from the gear features listed below: profile line, flank line, tip circle diameter, root circle diameter, tooth pitch.

It may be provided that one or more deviations are determined from measured values of the measurement, in particular selected from the following list: pitch deviation, entanglement, profile line deviation, flank line deviation, profile angle deviation, flank line angle deviation, torsion, longitudinal crowning, profile crowning, tip relief, end relief.

The optical measuring system can have a confocal chromatic distance sensor. The confocal chromatic distance sensor is in particular a point sensor. In particular, the point sensor can be used to measure individual measuring points one after the other. Each individual measuring point can be detected independently and separately from other measuring points by means of the point sensor. In other words, the point sensor can be used in particular to detect a single measuring point without simultaneously detecting other measuring points. Three spatial coordinates can be assigned to each individual measuring point, e.g. an x-value, a y-value and a z-value in a Cartesian coordinate system x-y-z.

It may be provided that the point sensor for optical distance measurement has a depth resolution. For example, as viewed along an optical axis of the point sensor, a depth, i.e. a distance of the optically probed surface or tooth flank along the optical axis in a predetermined coordinate system, can be measured in a depth measuring range along the optical axis, e.g. a distance to an origin of the predetermined coordinate system or to another geometric reference, such as the position of a lens or similar. It may be provided that the distance measurement is carried out one-dimensionally along an optical axis and three-dimensional measured values can be calculated based on the position of the optical measuring system.

It may be provided that the depth measuring range covers at least 0.5 mm, in particular at least 2 mm. It may be provided that the depth measuring range is less than 15 mm. In particular, it may be provided that the depth measuring range is greater than or equal to 0.5 mm and less than or equal to 15 mm, in particular greater than or equal to 2 mm and less than or equal to 15 mm.

For example, a depth, i.e. a distance of the optically probed surface or tooth flank along the optical axis can be measured in a predetermined coordinate system—e.g. a distance to an origin of the predetermined coordinate system or to another geometric reference, such as the position of a lens or the like—as viewed along an optical axis of the point sensor in a depth measuring range of a few centimeters or a few millimeters or in a depth measuring range of less than one millimeter along the optical axis. The distance information from the point sensor can be used in particular to generate a three-dimensional measuring point, wherein information on the axis positions of a coordinate measuring machine carrying the optical point sensor can be taken into account. It may be provided that the distance measurement is carried out one-dimensionally along an optical axis and three-dimensional measured values can be calculated based on the position of the optical measuring system.

According to a second aspect, the disclosure relates to a coordinate measuring machine set up for carrying out a method according to the disclosure.

### BRIEF DESCRIPTION OF THE DRAWINGS

The disclosure is described in more detail below with reference to a drawing illustrating exemplary embodiments. The drawings show schematically in each case:

FIG. 1 shows a gearwheel with an optical measuring system;

FIG. 2 shows a relative radiant power of a light source plotted against the wavelength;

FIG. 3 shows a coordinate measuring machine according to the disclosure;

FIG. 4 shows a gearwheel with an optical measuring system of the coordinate measuring machine;

FIG. 5 shows relative radiant power of a light source plotted against the wavelength; and

FIG. 6 shows a flow chart of a method according to the disclosure.

### DETAILED DESCRIPTION OF THE DRAWINGS

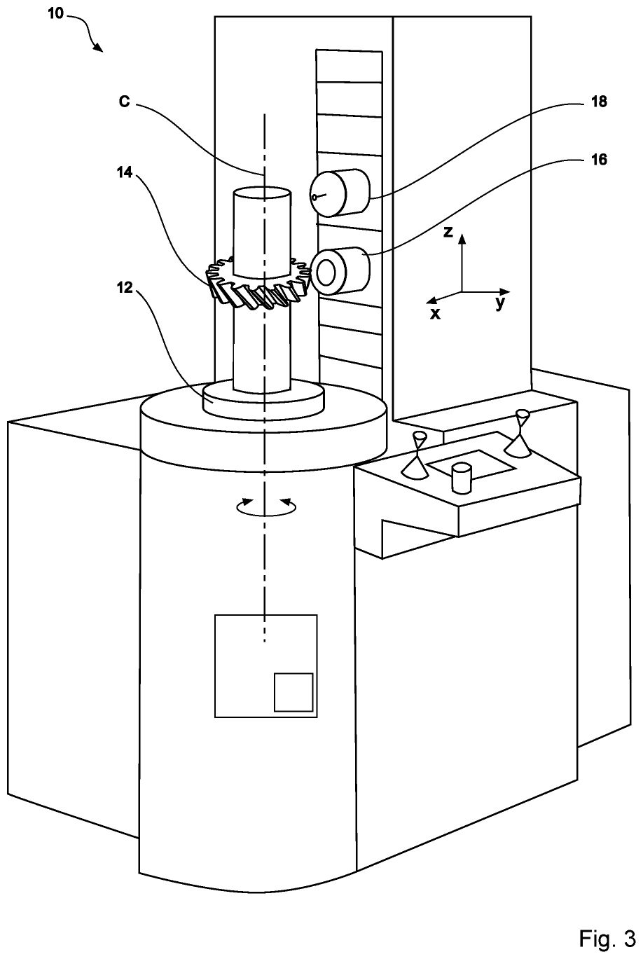

FIG. 3 shows a perspective view of a coordinate measuring machine 10 according to the disclosure. The coordinate measuring machine 10 has a turntable 12 on which a component 14 to be measured is rotatably held. The component 14 to be measured is a gearwheel.

The coordinate measuring machine 10 has an optical measuring system 16. The coordinate measuring machine 10 has a tactile measuring system 18.

The optical measuring system 16 and the tactile measuring system 18 can each be moved along the axes of the Cartesian coordinate system x, y, z relative to the gearwheel 14 by means of linear axes.

The gearwheel 14 can be rotated about an axis of rotation C by means of a rotary drive of the turntable 12.

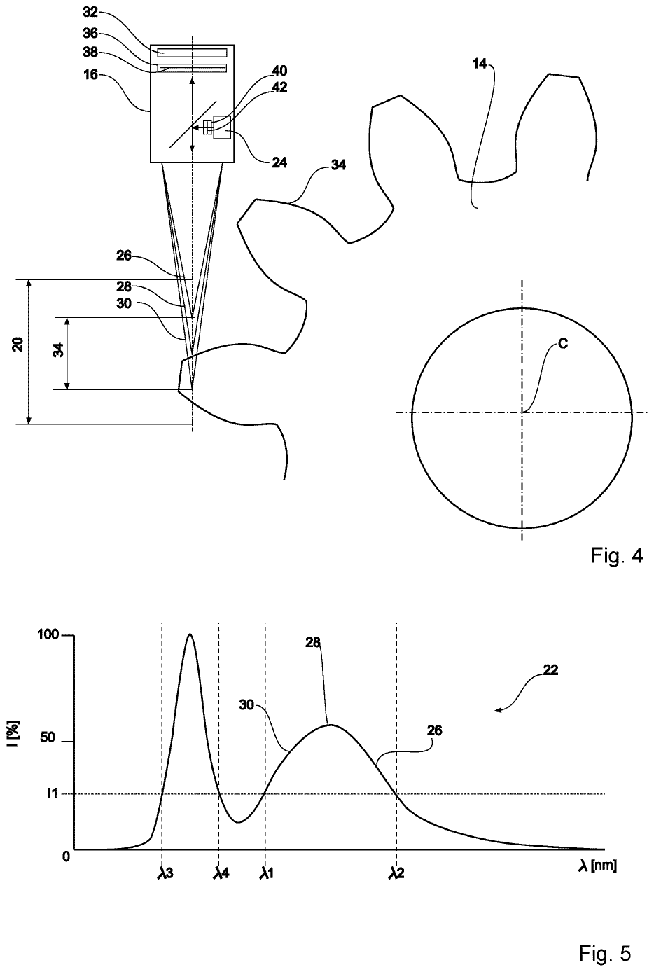

FIG. 4 schematically shows the optical measuring system 16 and the gearwheel 14 in a plan view along the axis of rotation C. An available measuring range 20 of the optical measuring system 16 is specified by an inhomogeneous spectrum 22 of a light source 24 of the optical measuring system 16. The inhomogeneous spectrum 22 of the light source 24 is shown in FIG. 5. FIG. 5 shows a relative radiant power I of the light source 24 plotted against the wavelength A. The relative radiant power I of the light source 24 is inhomogeneous.

The optical measuring system 16 is a confocal chromatic distance sensor. The measuring range 20 of the confocal chromatic distance sensor 16 results from the fact that wavelengths 26, 28, 30 are focused at different, known distances from the distance sensor 16. The position of an optically detected measuring point 34 of the gearwheel 14 can be measured by a spectral evaluation of the reflected light by means of a spectrometer 32 of the confocal chromatic distance sensor 16.

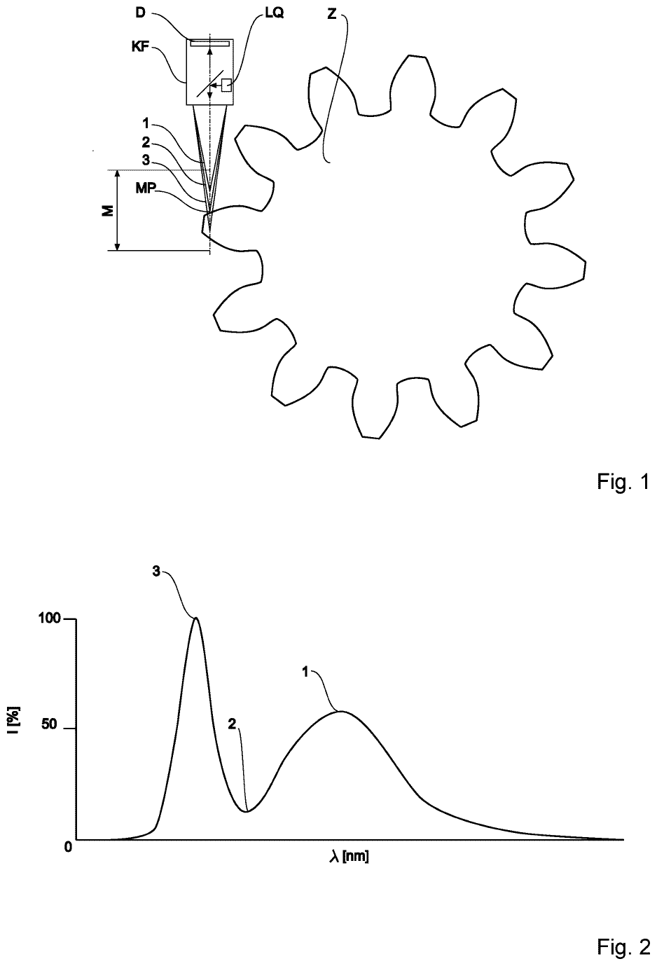

In order to avoid the incorrect measurement described at the beginning with reference to FIGS. 1 and 2, a reduced measuring range 34 is determined in accordance with the disclosure, which is smaller than the available measuring range 20.

The reduced measuring range 34 is set by reducing the spectral bandwidth of the optical measuring system 16, wherein in the present example only wavelengths greater than λ1 and less than λ2 are used for which a relative radiation intensity of the light source 24 is greater than 11 (see FIG. 5). This ensures that in the reduced measuring range 34, only wavelengths are used to measure the position of measuring points that are provided with a sufficiently high radiation intensity by the light source 24 of the optical measuring system 16.

Alternatively, the measurement could also be carried out with wavelengths greater than λ3 and less than λ4, for example, provided that the reduced measuring range resulting from this wavelength range covers the measuring range required to measure the geometric feature of the gearwheel to be measured.

Determining the reduced measuring range 34 essentially includes the present case of determining the threshold value 11, i.e. the minimum required relative radiation intensity of the light source 24, which is at least required for reliable measurement of the geometric feature of the component 14 to be measured. For example, it may be provided that the geometric feature is the tooth pitch of the gearwheel 14, i.e. the tooth pitch of the gearwheel 14 is to be determined by the measurement process.

In order to determine the threshold value 11, several parameters of the optical measuring system, such as the numerical aperture and the bandwidth and distribution of the spectrum of the light source 24 already shown in FIG. 5, can be provided. Furthermore, component-specific parameters, such as a roughness of the tooth flanks 34 of the gearwheel 14 to be optically probed, an angle of incidence of a measuring light emitted by the light source and a measuring range or the like required to detect the geometric feature to be measured can be provided. The required measuring range results in particular from a specified nominal geometry of the gearing 14.

If, for example, a profile line section of a tooth flank 34 is to be measured, the target geometry of the gearing can be used to calculate which measuring range or measuring depth is required to cover the entire profile line to be measured.

The reduced measuring range 34 can be defined or calculated from the aforementioned parameters.

In this case, the threshold value 11 is 1.3% of the maximum intensity of 100%. The diagram in FIG. 5 is to be understood schematically in this respect, as the threshold 11 has not been drawn at 1.3%.

Alternatively or additionally, it may be provided that a reference component is measured, wherein a quality criterion of an optical image of measurement points over the spectrum of the light source is recorded during the measurement. For example, the intensity detected by the detector 32 for each measurement point can be recorded in order to assess the quality of the image.

It may be provided that the spectral bandwidth of the optical measurement system 16 is restricted by limiting a spectral bandwidth of the detector 32 of the optical measurement system 16. For this purpose, a spectral filter device 36 with a filter element 38 can be connected upstream of the detector 32. Alternatively or additionally, the spectral bandwidth of the optical measuring system 16 is restricted by not reading out one or more areas of the detector 32. Similarly, a spectral filter device 40 with a filter element 42 can be connected downstream of the light source 24.

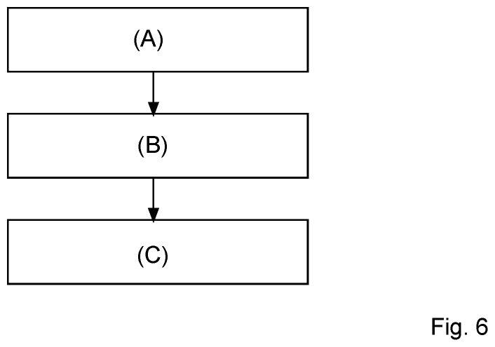

The method according to the disclosure therefore has the method steps of (FIG. 6): (A) providing the component 14 to the coordinate measuring machine 10, wherein the coordinate measuring machine 10 comprises the optical measuring system 16 and wherein the available measuring range 20 of the optical measuring system 16 is predetermined by the inhomogeneous spectrum 22 of the light source 24 of the optical measuring system 16; (B) determining the reduced measuring range 34 of the optical measuring system 16, wherein the reduced measuring range 34 is smaller than the available measuring range 20; and (C) measuring the geometric feature of the component 14 to be measured, wherein the reduced measuring range 34 is used and wherein the reduced measuring range 34 is set by limiting the spectral bandwidth of the optical measurement system 16.

Alternatively, it may be provided that step (B) is omitted if the reduced measuring range 34 of the optical measuring system 16 is fixedly predetermined and the restricted spectral bandwidth is not adapted to the specific component or measurement task, but is also fixedly predetermined and is used as standard for the measurement of gearings on the coordinate measuring machine. In this respect, according to this alternative, the geometric feature of the component 14 to be measured is measured in step (C), wherein the reduced measuring range 34 is used and wherein the reduced measuring range 34 is predetermined by a restriction of the spectral bandwidth of the optical measuring system 16.

1. A method including the following, steps of:
providing a component on a coordinate measuring machine, wherein the coordinate measuring machine has an optical measuring system and wherein an available measuring range of the optical measuring system is predetermined by an inhomogeneous spectrum of a light source of the optical measuring system, and
measuring a geometric feature of the component to be measured, wherein a reduced measuring range is used, wherein the reduced measuring range is smaller than the available measuring range.

2. The method according to claim 1,
wherein
the reduced measuring range is set by restricting a spectral bandwidth of the optical measuring system
or
the reduced measuring range is predetermined by restricting a spectral bandwidth of the optical measuring system.

3. The method according to claim 2,
wherein
the spectral bandwidth of the optical measuring system is restricted by restricting a spectral bandwidth of a detector of the optical measuring system.

4. The method according to claim 3,
wherein
the restriction of the spectral bandwidth of the detector is carried out by at least one spectral filter device which is assigned to the detector.

5. The method according to claim 3,
wherein
the restriction of the spectral bandwidth of the detector is carried out by not reading out one or more regions of the detector.

6. The method according to claim 3,
wherein
the detector is a wavelength-dependent detector.

7. The method according to claim 2,
wherein
the restriction of the spectral bandwidth of the optical measuring system carried out by adapting an evaluation of measured values.

8. The method according to claim 2,
wherein
the restriction of spectral bandwidth of the optical measuring system is carried out by adjusting the light emitted by the light source after the light strikes the component.

9. The method according to claim 2,
wherein
the spectral bandwidth of the optical measuring system is restricted by a restriction of a spectral bandwidth of the light source of the optical measuring system.

10. The method according to claim 9,
wherein
at least one spectral filter device is assigned to the light source.

11. The method according to claim 9,
wherein
the light source comprises a laser and the laser is detuned to limit the spectral bandwidth of the light source.

12. The method according to claim 9,
wherein
the restriction of the spectral bandwidth of the optical measuring system is carried out by adjusting the light emitted by the light source before the light strikes the component.

13. The method according to claim 1,
wherein
the reduced measuring range of the optical measuring system is determined before the measurement, wherein the determination of the reduced measuring range includes the following method steps:
providing one or more parameters of the optical measuring system, such as the numerical aperture, the bandwidth and the distribution of the spectrum of the light source,
providing one or more component-specific parameters, such as a roughness of a component surface, an angle of incidence of a measuring light emitted by the light source, a measuring range required to detect the geometric feature to be measured, a target component geometry, and
defining the reduced measuring range on the basis of one or more parameters of the optical measuring system and on the basis of one or more component-specific parameters.

14. The method according to claim 13,
wherein
the determination of the reduced measuring range includes the following method steps:
measuring a reference component, wherein a quality criterion of an optical image of measurement points over the spectrum of the light source is recorded during the measurement, and
defining the reduced measuring range as a range or as a plurality of ranges of the spectrum for which the quality criterion is fulfilled.

15. The method according to claim 14,
wherein
an exposure time and/or an illumination intensity are recorded for each measuring point, wherein the quality criterion has threshold values of the exposure time and/or the illumination intensity to be fulfilled.

16. The method according to claim
wherein
a first spectral bandwidth range (λ1-λ2) is assigned to the reduced measuring range
and/or
a second spectral bandwidth range (λ3-λ4) is assigned to the reduced measuring range
and/or
in that a relative radiant power is greater than a threshold value (I1) for each wavelength (λ) of the reduced measuring range

17. The method according to claim lone
wherein
the coordinate measuring machine has three linear axes for executing relative movements between the component and the optical measuring system,
wherein a relative movement is executed during the measurement by at least one of the three linear axes;
and/or
the coordinate measuring machine has a rotational axis for executing a rotational component movement, wherein a rotation of the component is executed during the measurement;
and/or
the coordinate measuring machine has a tactile sensor, in particular a measuring probe with a probe ball.

18. The method according to claim 1,
wherein
the component has a gearing or is a gearwheel, such as a bevel gear, a spur gear or the like, wherein the determination of the reduced measuring range of the optical measuring system is carried out taking into account a previously known geometric feature or using a plurality of previously known geometric features, selected from the gearing features listed below: module, number of teeth, helix angle, pitch direction, tip circle diameter, root circle diameter, tip cone angle, root cone angle, spiral angle, spiral direction, tooth pitch.

19. The method according to claim 1,
wherein
the optical measuring system comprises a confocal chromatic distance sensor.

20. A coordinate measuring machine,
set up for carrying out a method according to claim 1.
